(19) United States
(12) Patent Application Publication
(10) Pub. No.: US 2019/0279207 A1
(43) Pub. Date: Sep. 12, 2019

(54) Systems and Methods for Payment Processing

(71) Applicant: JPMorgan Chase Bank, N.A., New York, NY (US)

(72) Inventors: Pio Abate, Mullica Hill, NJ (US); Wim Leon Geurden, Ridgefield, WA (US); Kendall Allen Kowalski, Powell, OH (US); Jason Troy Penshorn, Grandview, OH (US); Donald A. Gammon, Pelham Manor, NY (US)

(21) Appl. No.: 14/044,336

(22) Filed: Oct. 2, 2013

Related U.S. Application Data
(60) Provisional application No. 61/708,817, filed on Oct. 2, 2012.

(51) Int. Cl. G06Q 20/40

(52) U.S. Cl. CPC G06Q 20/40

(57) ABSTRACT

The invention provides a system and method to perform financial transactions. The system may be in the form of a tangibly embodied computer processor maintained by a primary financial entity. In one embodiment, the system inputs a transaction request and performs processing of the transaction request to authorize the transaction. Such processing may include (1) determining if the transaction request satisfies a set of rules; (2) inputting aggregated data to determine a risk associated with the transaction request, the aggregated data including data associated with (a) an account of the first customer maintained by the primary financial entity, and (b) at least one account of the first customer maintained by a secondary financial entity; (3) upon determining that (a) the transaction does satisfy the set of rules and (b) that the risk associated with the transaction request satisfies a threshold value, the system authorizing the transaction request.

### RELATED PATENT APPLICATION

This application claims priority to U.S. Provisional Patent Application 61/708,817 filed Oct. 2, 2012, the content of which is incorporated herein by reference in its entirety.

### BACKGROUND OF THE INVENTION

The invention relates generally to electronic commerce, and more particularly to systems and methods for performing payment and other transactions, and to financial planning.

In the present technological environment, people routinely perform transactions online, transactions at brick and mortar merchants, as well as a wide variety of other transactions. For example, such online transactions might be in the form of a customer purchasing an item from a particular merchant's website. Such processing typically involves the customer interfacing with the merchant website so as to select a particular item to be purchased, and thereafter completing the purchase through further interface with the merchant website. Alternatively, the customer might interface with the merchant in a brick and mortar physical location. The merchant requests approval of the requested transaction through interfacing with a financial entity, such as the bank which issued the customer's credit card, for example. Additionally, it may be desired by a customer to schedule or in some manner otherwise coordinate payments, such as to schedule a payment for some future time.

However, current processing techniques are insufficient in some respects to provide desired convenience for people, as well as to provide adequate tools for account creation and financial planning in conjunction with accounts of a customer. Also, current processing techniques are insufficient in some respects to provide efficient processing, by a financial entity, of a requested transaction using data that is potentially available to the financial entity processing the transaction.

Therefore, improvements are needed to accommodate the evolving needs of people and of financial entities in performing transactions. The systems and methods of the invention provide such improvements.

### BRIEF SUMMARY OF THE INVENTION

The invention provides a system and method to perform financial transactions. The system may be in the form of a tangibly embodied computer processor maintained by a primary financial entity. The system may include a communication portion that provides communication to each of a plurality of secondary financial entity computer systems, a plurality of merchant computer systems, and a plurality of customer devices. In one embodiment, the system inputs a transaction request, for a first customer, from at least one of a first merchant computer system and a first customer device of the first customer; and the system performs processing of the transaction request to authorize the transaction. Such processing may include (1) determining if the transaction request satisfies a set of rules; (2) inputting aggregated data to determine a risk associated with the transaction request, the aggregated data including data associated with (a) an account of the first customer maintained by the primary financial entity, and (b) at least one account of the first customer maintained by a secondary financial entity; (3) upon determining that (a) the transaction does satisfy the set of rules and (b) that the risk associated with the transaction request satisfies a threshold value, the system authorizing the transaction request, and (4) outputting a communication, to at least one of the first merchant computer system and the first customer device, indicating approval of the transaction.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram of a financial system 1 in accordance with one embodiment of the invention.

FIG. 2 is a high-level flowchart showing payments processing in accordance with one embodiment of the invention.

FIG. 3 is a flowchart showing in further detail the “system interfaces with the user device to perform user interface processing” step 300 of FIG. 2 in further detail, in accordance with one embodiment of the invention.

FIG. 4 is a flowchart showing in further detail the “interface with the user to provide general information including account information” of FIG. 3 in further detail, in accordance with one embodiment of the invention.

FIG. 5 is a flowchart showing the “interface with user to integrate secondary financial system with the user's account set” step 320 of FIG. 3 in further detail, in accordance with one embodiment of the invention.

FIG. 6 is a flowchart showing the “interface with user to add account to user's account set” step 330 of FIG. 3, in accordance with one embodiment of the invention.

FIG. 7 is a flowchart showing in further detail the “interface with user to set respective rules for use of a particular account in the user's account set” step 3 for a FIG. 3, in accordance with one embodiment of the invention.

FIG. 8 is a flowchart showing in further detail the “interface with the user to set up a payment” step 350 of FIG. 3, in accordance with one embodiment of the invention.

FIG. 9 is a flowchart showing in further detail the “interface with user to set communication preferences including what communication channel or channels the user receives communications on, in accordance with one embodiment of the invention.

FIG. 10 is a flowchart showing in further detail the “system interfaces with the user device and/or merchant system to perform transaction processing” step 400 of FIG. 2, in accordance with one embodiment of the invention.

FIG. 11 is a flowchart showing in further detail the “determine if requested transaction satisfies retrieved rule sets imposed on the particular account of the user” step 430 of FIG. 10, in accordance with one embodiment of the invention.

FIG. 12 is a flowchart showing in further detail the “perform integrated system processing based on data in all banks that are associated with the user account set and assign user integrated system score” step 440 of FIG. 10, in accordance with one embodiment of the invention.

FIG. 13 is a flowchart showing in further detail the “perform integrated account processing based on data from all user's integrated account, and assign the user integrated account score (customer level)” step 460 of FIG. 10, in accordance with one embodiment of the invention.

FIG. 14 is a flowchart showing in further detail the “perform further processing to assess whether the transaction is authorized including processing risk scores” step 470 of FIG. 10, in accordance with one embodiment of the invention.

FIG. 15 is a flowchart showing in further detail the “system interfaces with and outputs information to the bank operating system and/or merchant” step 500 of FIG. 2, in accordance with one embodiment of the invention.

FIG. 16 is a flowchart showing processing performed by a payment system, in accordance with one embodiment of the invention.

### DETAILED DESCRIPTION OF THE INVENTION

Hereinafter, aspects of the invention in accordance with various embodiments will be described. As used herein, any term in the singular may be interpreted to be in the plural, and alternatively, any term in the plural may be interpreted to be in the singular. The terms “customer” and “user” are used herein interchangeably.

The systems and methods of the invention are directed to a payment processing engine characterized herein as a “payment system.” The payment system may constitute an “enterprise payment hub” in that the payment system performs payment processing amongst a variety of financial entities. The payment system of the invention may be maintained by a particular financial entity. The payment system may include an “integrated system of record,” wherein such integrated system of record includes both (1) at least one primary system of record (maintained by the primary financial entity that maintains the payment system), and (2) at least one external system of record (maintained by a financial entity separate from the primary financial entity). With the arrangement of the system, the various external system of record accounts (in the integrated system of record) are treated in various ways as though disposed in the primary system of record. Such treatment includes various aspects of the account such as ownership, customer profile, transaction activity, risk scoring, account problems, and fraud activity, for example. The payment system may be maintained on a suitable server or servers, for example.

The integrated system of record may perform processing to afford various advantages. For example, activity occurring in an external system of record (which is included in the integrated system of record) may be integrated into a customer's profile. The integrated system of record may provide a more accurate picture on various activities (such as fraudulent activity, for example) since a larger portion of a customer's accounts are monitored, and relevant data input from such monitoring. Further, the integrated system of record allows for more effective risk analysis, such as risk scoring. For example, if a customer is consistently diligent in maintenance of her or his accounts (in both (1) customer accounts disposed in the primary system of record and (2) customer accounts disposed in external systems of record) then that customer may be afforded a greater risk tolerance. Such greater risk tolerance may provide for a financial entity to extend greater credit, faster movement of funds, and diminished need to re-authenticate, for example. Illustratively, the payment processing described herein, including utilizing information from a customer's integrated accounts, (including payment history of the customer) may be used in a wide variety of financial decisioning. For example, information from the integrated accounts may reflect a good payment history on previous loans that may help a customer be approved for a new loan.

The integrated system of record of the invention provides for what might be characterized as a single flow of funds for accounts maintained in the integrated system of record. In other words, transactions, debits, credits, and other processing may all be processed and viewed (by the customer, for example) in an integrated manner. This allows the customer to more closely monitor the “big picture” of his or her financial activity. In general, there are various advantages provided by the payment system of the invention including, for example, (1) consistency in account management and payment processing, (2) enhanced ability to research and investigate payment processing activity, (3) enhanced ability to perform payment processing in real-time, (4) simplification of payment processing, and (5) more effective bill payment since a larger number of accounts of the customer are integrated within the integrated system of record.

The payment system allows a customer to schedule and control the flow of funds to and from his or her account(s) using what might be characterized as an “account control rule set” (AC rule set). The AC rule set allows a customer to schedule a payment from a particular account and/or a deposit into a particular account. For example, a customer may owe $3000 in an upcoming month for a credit card, mortgage, and auto loan. To perform such payments, the customer may utilize an AC rule set to schedule payments from one or more of the customer's accounts. Of particular note, the customer may choose from different types of AC rule sets. For example, a customer may be given an option between (1) a more complex AC rule set for which might be characterized as a “specialized account”, and (2) a more simple AC rule set for which might be characterized as a “general account”. The complex AC rule set may have more capabilities and/or options as compared to the simple AC rule set. However, the complex AC rule set may be more complicated for the customer (user) to use and engage. The invention may provide other types of AC rule sets tailored to particular situations, types of customers, business environments, and/or types of accounts, for example. Such other types of AC rule sets might be a subpart of the complex AC rule set—simple AC rule set dichotomy or distinct from such dichotomy. An AC rule set provides a customer with various fund transfer options, for example, which makes payment scheduling, deposit scheduling and planning easier and more effective. In particular, a customer might be provided with a collection (and corresponding descriptions) of AC rule sets and be able to choose the particular AC rule set that is most close to his or her situation. Upon a customer choosing a particular AC rule set, there may be various preferences and/or rules controlled (i.e., which may be set) by the customer. Each of the AC rule sets would exist under the constraints (such as rules and/or regulations) of the particular accounts possessed by the customer, as well as the constraints of the financial entity (e.g. bank) in general.

One example of an AC rule set may be a “529 plan” AC rule set. A 529 plan is an education savings plan operated by a state or educational institution. Such a plan is a tax-advantaged investment vehicle designed to help students and families allocate funds for future educational expenses, such as college costs. In using funds associated with a 529 plan, a customer (student for example) must abide by different rules and regulations. In the invention, a customer may select to use the 529 plan AC rule set. In conjunction with this selection, the customer specifies that a particular account or funds card for example (implicated in her use of the rule set) is indeed an account subject to a 529 plan. As a result, the system applies appropriate constraints in use of that 529 account. Accordingly, the system would allow the customer to schedule future payments to pay tuition costs. However, the system would not allow the customer to schedule a future payment for something totally unrelated to education.

The payment system of the invention provides a wide variety of other features. The system provides various tools to assist the customer in making scheduled payments and financial planning. The AC rule set feature of the invention provides specialized processing, helpful to the customer. A customer might have one or more accounts associated with one AC rule set, and also have other accounts associated with another distinct AC rule set. The payment system may provide balance sheet capabilities. That is, for example, a customer's accounts and/or obligations may be tied into a balance report that includes both assets and obligations. The balance report may also reflect certain constraints that the associated accounts exist under, such as in the case of the 529 plan AC rule set, for example.

The invention includes various other novel features.

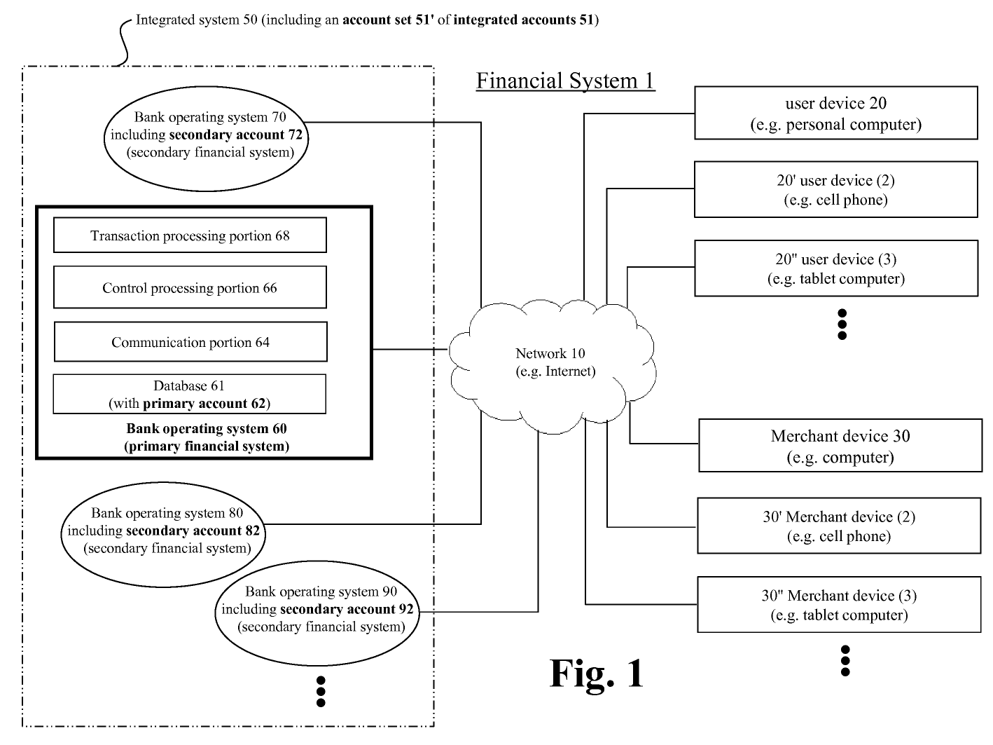

FIG. 1 is a block diagram of a financial system 1 in accordance with one embodiment of the invention. As shown, the financial system 1 includes a bank operating system 60, which may be characterized as a primary financial system. The financial system 1 also includes a plurality of secondary financial systems (70, 80, 90). As shown in FIG. 1, the secondary financial systems include a bank operating system 70, a bank operating system 80, and a bank operating system 90, in accordance with one embodiment of the invention. The bank operating system 70 includes a secondary account 72. The bank operating system 80 includes a secondary account 82. Further, the bank operating system 90 includes a secondary account 92. Further details of such bank operating systems, and the interrelationship between such bank operating systems, are described below. As shown in FIG. 1, the bank operating systems (60, 70, 80, 90) may collectively be characterized as an integrated system 50. The integrated system 50 includes an account set 51′ of integrated accounts 51.

In accordance with one embodiment of the invention, the bank operating system 60 includes a transaction processing portion 68, a control processing portion 66, and a database 61. In general, the transaction processing portion 68 performs various processing of transactions. The control processing portion 66 performs various processing associated with account formation of a user and manipulation of an account by a user. Various further processing of the transaction processing portion 68 and the control processing portion 66 are described below. Also, the bank operating system 60 includes a database 61. The database 61 includes a primary account 62 of a user, in this example. The bank operating system may also include a communication portion 64 to provide data communications with other processing portions in the financial system 1.

As noted above, the bank operating systems (60, 70, 80, 90) may be characterized as an integrated system 50 that includes an account set 51′ of integrated accounts 51. Such integrated accounts may include the primary account 62 (in the bank operating system 80) as well as the secondary account 72, the secondary account 82, and the secondary accounts 92.

Each of the bank operating systems may be in communication with each other via a suitable network 10. In the example of FIG. 1, it is shown that to the network may illustratively be the Internet. However, it is appreciated that any suitable network may be utilized to connect the various bank operating systems, including a suitable internal network and/or external network.

The financial system 1 also includes a plurality of user devices (20, 20′, and 20″). The user devices might include, for example, a personal computer, a cell phone and/or a tablet computer. Various processing of the user devices are described below. The financial system 1 also includes a plurality of merchant devices (30, 30′, and 30″). The merchant systems may be in the form of a computer, a cell phone, and/or a tablet computer, for example. Illustratively, the merchant system in the form of a computer might be constituted by a computer system (such as a server) supporting an online business of the merchant. Also, the merchant system might be in the form of a computer system supporting a physical brick and mortar merchant location. The user devices and the merchant systems may be connected to each other (and to the other processing components of FIG. 1) via a network, such as the Internet, or any other suitable network as desired. As reflected by the three “dots” of FIG. 1 associated with component types, further components may be included. Aspects of the payment processing described herein are illustratively described in the context of a transaction between a customer and a merchant. However, it is appreciated that the features described herein are not limited to such payment scenario. For example, features of the payment processing described herein may well be used to perform a transfer of funds between a customer and any financial entity, such as a bank, for example. Also, features of the payment processing described herein may well be used to perform a transfer of funds between two persons, such as between a first customer and a second customer.

Further details of the financial system 1 and the various processing performed by the components of the financial system 1 are described in various detail below.

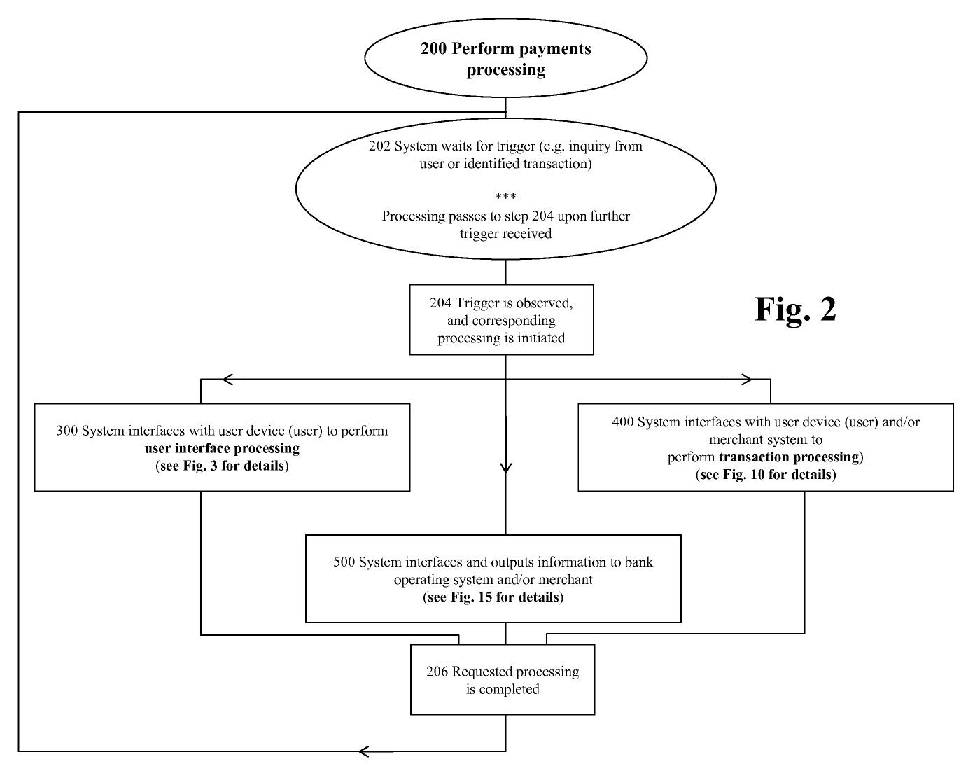

FIG. 2 is a high-level flowchart showing payments processing in accordance with one embodiment of the invention. Illustratively, the processing of FIG. 2 may be performed by the bank operating system 60 (of FIG. 1). As shown, the processing of FIG. 2 starts in step 200 and passes to step 202. Step 202 reflects initiation of processing. Specifically, in step 202, the system waits for a trigger to initiate requested processing. For example, that trigger might be an inquiry from a user, the input of a transaction for processing, or a request for information from a merchant system or an administrative system, for example. Accordingly, step 204 of FIG. 2 reflects that a trigger has been observed and that the processing that corresponds to the observed trigger is initiated.

The corresponding processing resulting from a particular trigger being observed may be constituted by any of step 300, step 400, and/or step 500 of FIG. 2, in accordance with one embodiment of the invention.

In the processing of step 300, the system interfaces with the user device, i.e. the human user, to perform user interface processing. Accordingly, the processing of step 300 constitutes a situation in which the user has initiated interface with the bank operating system 60 such as through a web interface. For example, the processing of step 300 might be a situation in which the customer wishes to create a new account or change attributes of an existing account, such as preferences in an existing account. Further details of the processing of step 300 are described below with reference to FIG. 2.

In the processing of step 400, the system interfaces with a user device and/or a merchant system to perform transaction processing resulting from initiation of a requested transaction. The requested transaction might be in the form of an online purchase initiated by the customer, for example. In conjunction with such online purchase, a merchant system and/or a customer system interfaces with the bank operating system 60 to perform the transaction. Further details of the processing of step 400 are described below with reference to FIG. 2.

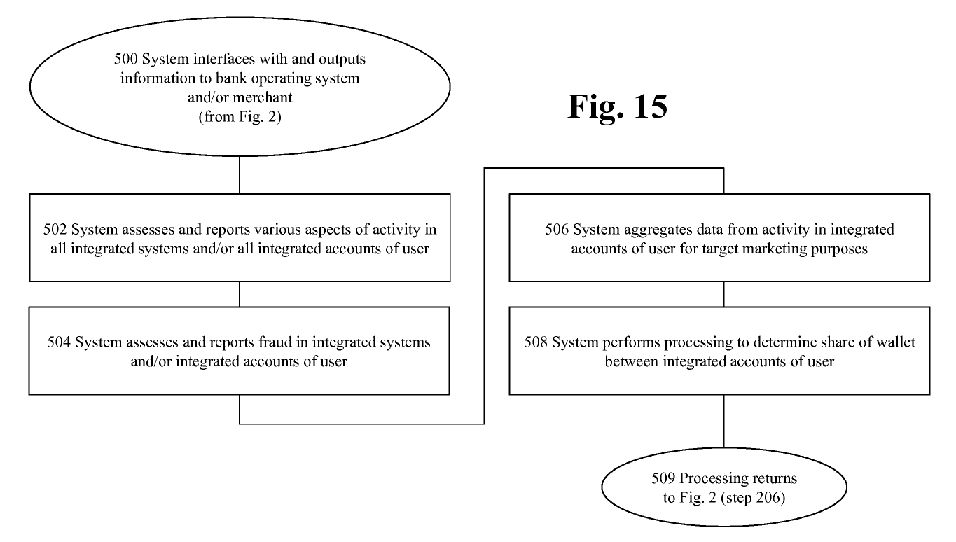

In the processing of step 500, the system interfaces with a bank operating system and/or a merchant to output desired information, in accordance with one embodiment of the invention. For example, the processing performed in step 500 might be constituted by the bank operating system 60 outputting analytics information regarding use of the system, aggregated transaction information regarding transactions performed by the customer, periodic reporting information, and/or other information. Further details of the processing of step 500 are described below with reference to FIG. 15.

Once the processing of step 300, step 400, or step 500 is completed, the processing of FIG. 2 then passes to step 206. Step 206 reflects that the requested processing has been completed. Accordingly, after step 206, the process returns to step 202 of FIG. 2. In step 202, the system waits for a further trigger from the customer, merchant system, or other system to perform further processing as requested.

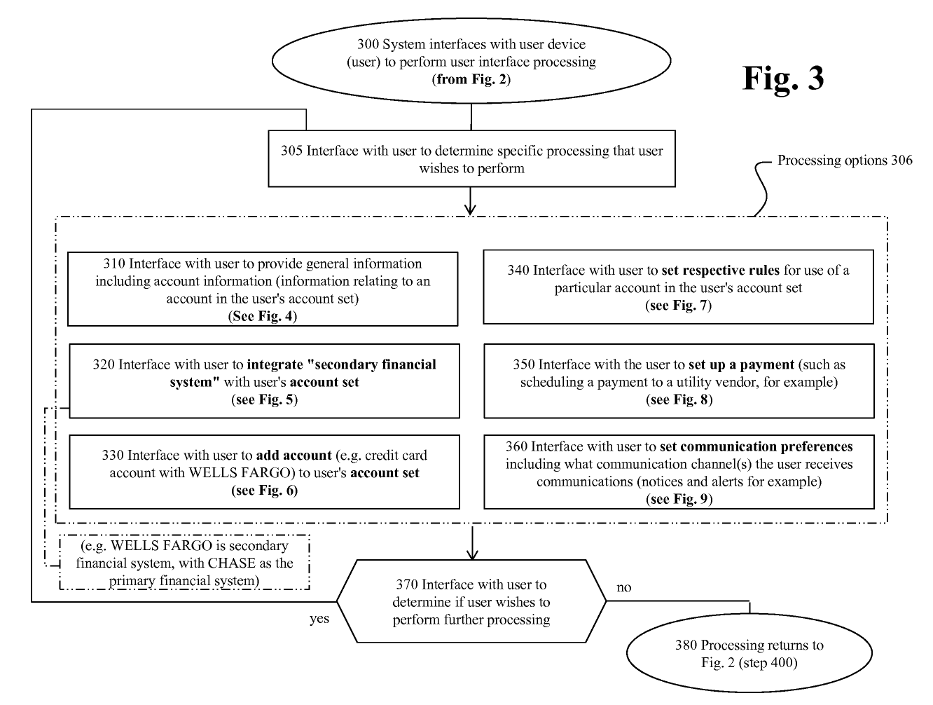

FIG. 3 is a flowchart showing in further detail the “system interfaces with the user device to perform user interface processing” step 300 of FIG. 2 in further detail, in accordance with one embodiment of the invention. The processing of FIG. 3 starts in step 300 and passes to step 305. For example, the processing of FIG. 3 might be performed by the bank operating system 60 of FIG. 1. In step 305, the system interfaces with the user to determine specific processing that the user wishes to perform. Such specific processing, illustratively, may be constituted by any of the processing options 306 as shown in FIG. 3.

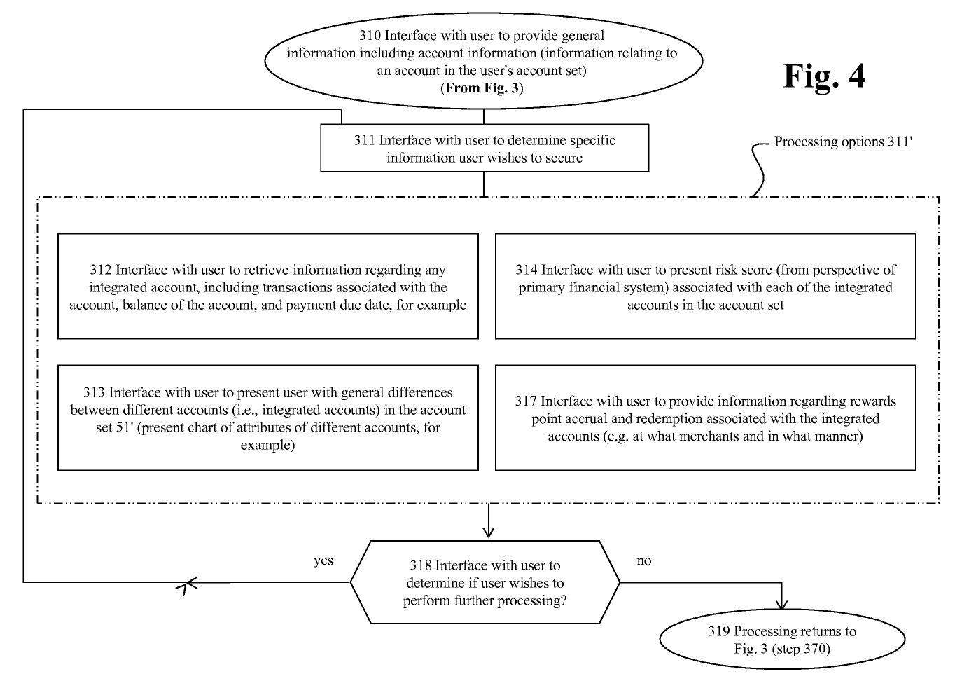

The user may have requested the processing of step 310. In step 310, the system interfaces with the user to provide general information including account information, for example, in accordance with one embodiment of the invention. In particular, the system might include information relating to an account in the user's account set. As described above, accounts in the user's account set 51′ may include primary account 62, secondary account 72, secondary account 82, and secondary account 92. Further details of the processing of step 310 are described below with reference to FIG. 4.

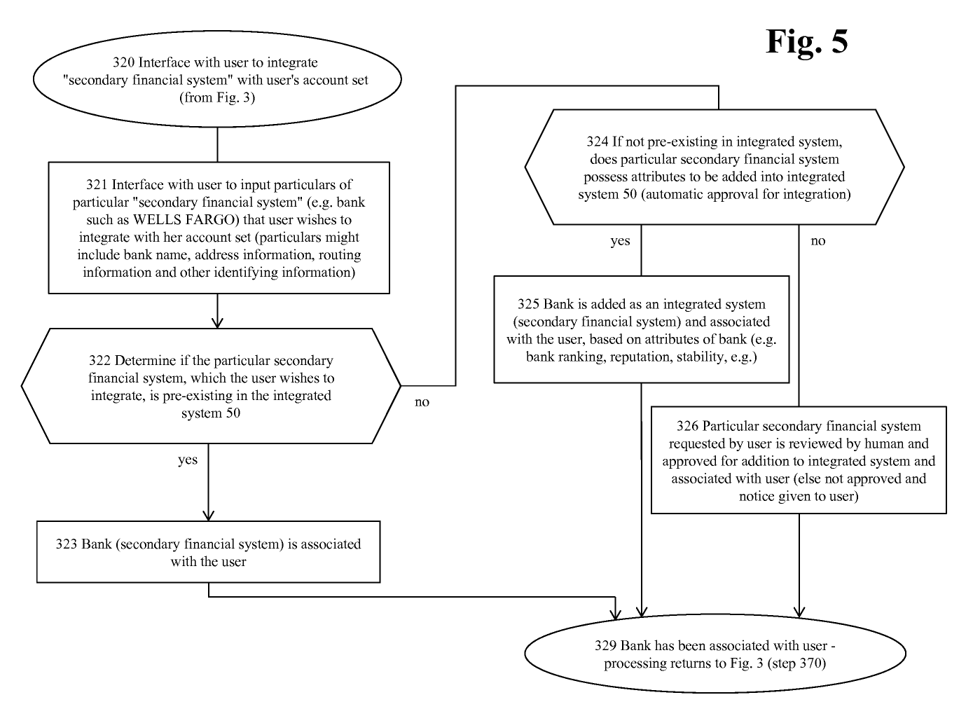

The user may have requested to perform the processing of step 320. In step 320 of FIG. 3, the system interfaces with the user to integrate a secondary financial system with the user's account set. Further details of the processing of step 320 are described below with reference to FIG. 5.

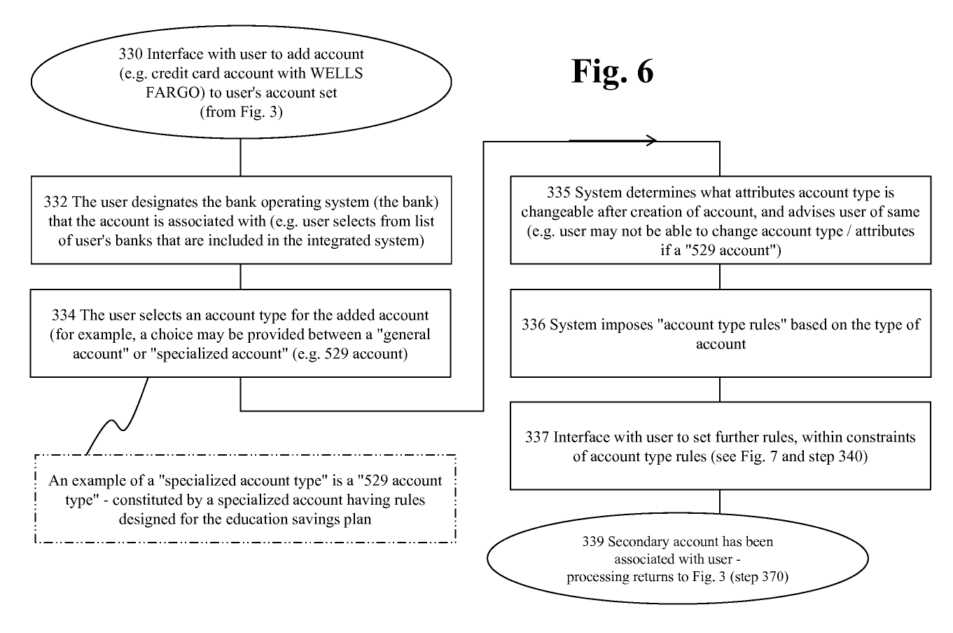

The user may have requested the processing of step 330. In step 330 of FIG. 3, the system interfaces with the user to add an account to the user's account set. For example, in such processing, the user may have requested to add the secondary account 92 of FIG. 1. Such secondary account 92 might be, for example, in the form of a credit card account with WELLS FARGO, with the primary account 62 being with JPMORGAN CHASE. Further details of the processing of step 330 are described below with reference to FIG. 6.

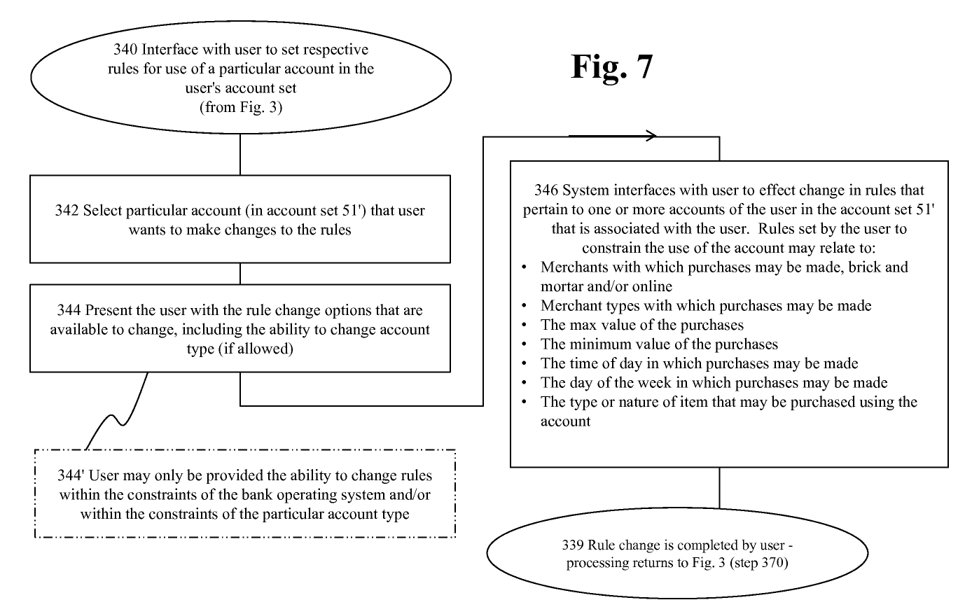

The user may have requested the processing of step 340. In step 340 of FIG. 3, the system interfaces with the user to set respective rules for use of a particular account in the user's account set. For example, a rule set by the customer might be a maximum value of a transaction associated with a particular credit card, for example. Further details of the processing of step 340 are described below with reference to FIG. 7.

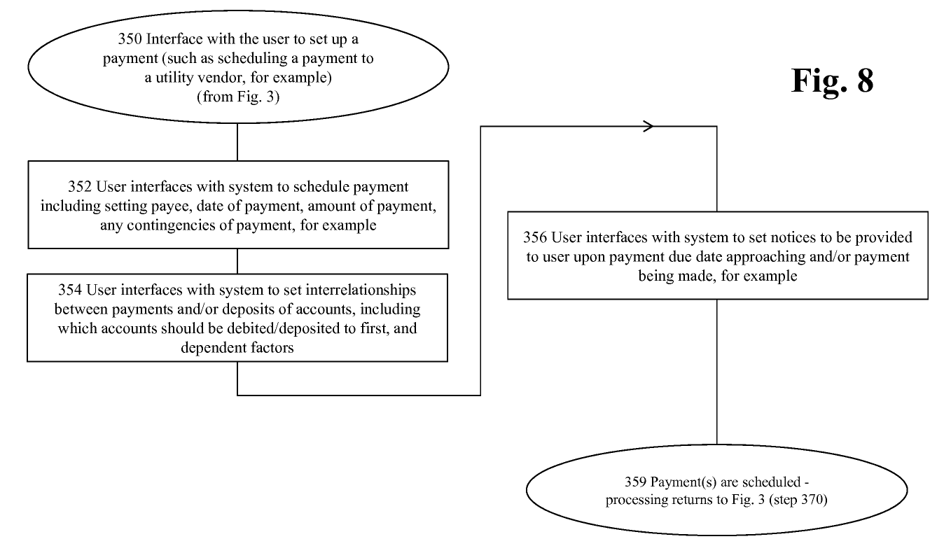

The user may have requested the processing of step 350. In step 350 of FIG. 3, the system interfaces with the user to set up a payment associated with one of the user's integrated accounts in the users account set 51′. For example, the user might set up a payment for a particular dollar amount to a desired merchant on a specified date. Further details of the processing of step 350 are described below with reference to FIG. 8.

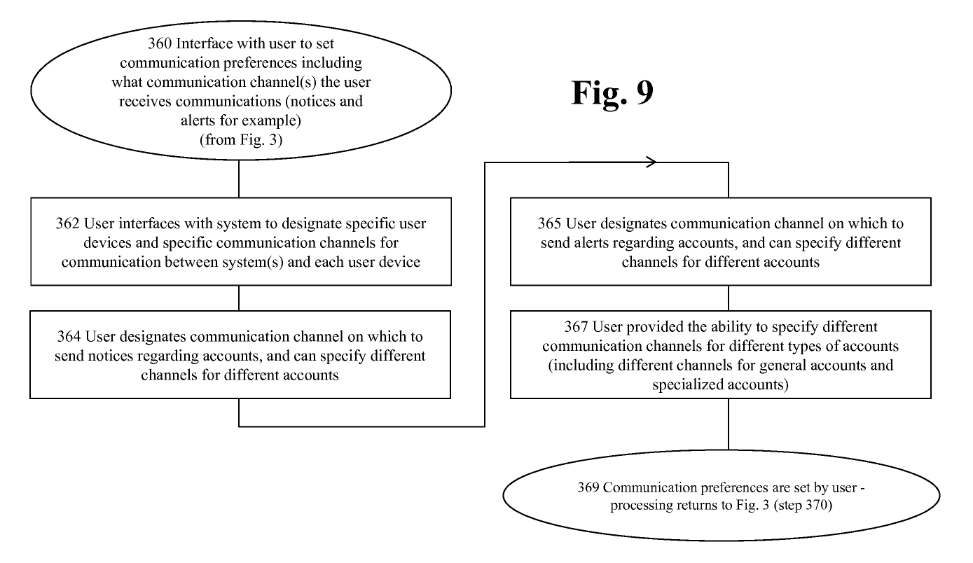

The user may have requested the processing of step 360 of FIG. 9. In step 360, the system interfaces with the user to set communication preferences including the particular communication channel that the user desires to receive particular communications. For example, in such interfacing, the user might specify that she wishes to receive monthly statements regarding her integrated accounts 51 via email and that the user wishes to receive any alerts via text message. Further details of the processing of step 360 are described below with reference to FIG. 9.

After any of the processing options 306 of FIG. 3, the processing passes to step 370 of FIG. 3. In step 370, decisioning is performed to determine if the user wishes to perform further processing. It should be appreciated that the processing of step 370 may take various forms. For example, upon the user completing a processing option 306, the user might simply terminate the interface. Such termination might be in the form of simply logging out of her account. In such situation, the processing of step 370 would be constituted by the communication with the user being terminated. Accordingly, the system would deem that the user does not wish to perform further processing, and processing would pass to step 380 of FIG. 3. On the other hand, the processing of step 370 might be constituted by the user affirmatively indicating that she does not wish to perform further processing. Such indication of a wish not to perform for the processing might be in the form of a user tapping a suitable button on the graphical user interface (GUI) presented to the user.

It may be the situation that the decisioning of 370 determines that the user does indeed wish to perform further processing. In such situation, the processing returns to step 305 of FIG. 3. In step 305 of FIG. 3, the system further interfaces with the user to determine the further specific processing that the user wishes to perform.

If it is determined in step 370, that no further processing is to be performed, the processing passes to step 380, as described above. In step 380, the process returns to FIG. 2, and specifically passes to step 400 of FIG. 2.

FIG. 4 is a flowchart showing in further detail the “interface with the user to provide general information including account information” of FIG. 3 in further detail, in accordance with one embodiment of the invention. Specifically, the account information may relate to an integrated account 51 in the user's account set 51′. As shown, the processing of FIG. 4 starts in step 310 and passes to step 311. In step 311, the system interfaces with the user to determine specific information that the user wishes to secure. Such specific processing, illustratively, may be constituted by any of the processing options 311′ as shown in FIG. 4.

The user may have requested the processing of step 312 of FIG. 4, in accordance with one embodiment of the invention. In step 312, the system interfaces with the user to retrieve information regarding any of the user's integrated accounts 51. For example, information regarding a particular integrated account may include data associated with the account such as transactions associated with the account, balance of the account, payment due date and other payment details, and other information.

The user may have requested the processing of step 313 of FIG. 4, in accordance with one embodiment of the invention. In step 313, the system interfaces with the user to present the user with general differences between different accounts. In particular, the processing of step 313 might include the system generating and presenting information regarding differences between the various integrated accounts 51 of the user. Such may be in the form of a chart showing attributes of different accounts laid out in such a manner that the customer may see differences in use or convenience of such accounts, for example. For example, the displayed information might include payment history between accounts, interest paid between accounts, interest accrued between accounts, reward points earned between accounts, and/or any other information associated with an account or accounts, for example. It is appreciated that various cost savings and/or imposed fees may be associated with payment processing described herein. For example, a transaction of funds between different accounts internal to the same financial entity may well be less costly then the transaction of funds between accounts of different financial entities. Such cost variation may be passed on to the customer in terms of cost savings and/or imposed fees. In general, fees may be different depending on the account used. For example, it may be the situation that no fee is imposed for using a checking account to pay an auto loan, but a $10 fee is imposed for using a credit card to pay the auto loan.

It is appreciated that such information presented is not limited to the user's integrated accounts 51 in the user's integrated account set 51′. That is, for example, the system might present information outside the user's integrated account set 51′ and in particular information of an aggregated nature. For example, the system might collect aggregated information (from other customers) regarding a new credit card program that J.P. MORGAN CHASE is initiating. Such aggregated information might be presented to the user to demonstrate the beneficial attributes of such new account.

The user may have requested the processing of step 314 of FIG. 4, in accordance with one embodiment of the invention. In step 314, the system interfaces with the user to present a risk score (from the perspective of the primary financial system) associated with each of the integrated accounts 51 in the user's account set.

The user may have requested the processing of step 317 of FIG. 4, in accordance with one embodiment of the invention. In step 317, the system interfaces with the user to provide information regarding rewards point accrual and/or redemption information associated with a particular integrated account or accounts 51. For example, such information might include accrual of rewards points at a particular merchant, redemption of rewards points at a particular merchant, and any particulars associated with such accrual or redemption. It is appreciated the information presented regarding rewards points may have some overlap with the information presented in the processing of step 312 of FIG. 4. Illustratively, the information presented to the user in the processing of step 317 might be more detailed than that information presented in step 312. Accordingly, it is appreciated that there may be various overlap in the processing and/or information involved in the processing of steps 312, 313, 314 and 317.

After performing one of the processing options 311′ of FIG. 4, the processing passes to step 318. In step 318, the system interfaces with the user to determine if the user wishes to perform further processing. If yes, i.e. the user does wish to perform further processing, the process returns to step 311 of FIG. 4. On the other hand, it may be the situation that the user does not wish to perform further processing. In such situation, the processing passes to step 319 of FIG. 4. In step 319, the processing returns to FIG. 3, and specifically to step 370 of FIG. 3.

FIG. 5 is a flowchart showing the “interface with user to integrate secondary financial system with the user's account set” step 320 of FIG. 3 in further detail, in accordance with one embodiment of the invention. As shown, the processing of FIG. 5 starts in step 320, and passes to step 321. In step 321, the system interfaces with the user to input particulars of the particular “secondary financial system” that the user wishes to integrate with her account set. For example, the secondary financial system might be a bank such as WELLS FARGO. Accordingly, the particulars of the secondary financial system might include the bank name, address information of the pain, routing information of the bank, and other identifying information of the bank, for example. After the user has entered this initial information, the processing passes to step 322.

In step 322, the system, such as the bank operating system 60, determines if the particular secondary financial system, which the user wishes to integrate into her integrated accounts, is pre-existing in the integrated system 50. For example, it might be the situation that the bank operating system 60 does not have a WELLS FARGO account in the integrated accounts 51 of a particular user requesting a new account be integrated, but that the bank operating system does indeed have other WELLS FARGO accounts (for other customers). If the determination step 322 is yes, i.e. it is determined that the particular secondary financial system is indeed pre-existing in the integrated system, then the processing passes to step 323. That is, such processing relates to validating another financial entity's information, such as another bank's information.

In step 323, the bank, i.e. the secondary financial system, is associated with the user. Thereafter, the processing passes to step 329 in which the bank is associated with the user in the system. On the other hand, if no in step 322, i.e. it is determined that the particular secondary financial system is not a pre-existing system, than the processing passes to step 324. In step 324, it is determined whether the particular secondary financial system possesses attributes so as to be automatically added into the integrated system 50. For example, the bank operating system 60 may have a listing of what might be characterized as “preapproved” banks or other financial institutions which are automatically approved if a user wishes to add an account associated with such financial entities. Accordingly, if yes in step 324, then the process passes to step 325. In step 325, the bank is added into the integrated system and associated with the user based on the attributes of the bank including bank ranking, reputation, stability and other attributes, for example.

On the other hand, if no in step 324, i.e. the particular secondary financial system does not possess attributes to be added into the integrated system 50 in an automated manner, the processing passes to step 326. In step 326, the particular secondary financial system requested by the user is reviewed by a human and approved for addition to the integrated system, and thereafter associated with the user. Alternatively, the particular secondary financial system (for which the user wishes to add an account) is reviewed and not approved. In such situation, suitable notice would be given to the customer regarding such non-approval.

Accordingly, after any of steps 323, 325, or 326 of FIG. 5, the processing passes to step 329. In step 329 of FIG. 5, the bank has been associated with the user (or has not been approved) and the processing returns to FIG. 3. Specifically, the processing returns to step 370 of FIG. 3.

FIG. 6 is a flowchart showing the “interface with user to add account to user's account set” step 330 of FIG. 3, in accordance with one embodiment of the invention. For example, the user may wish to add a further credit card from a financial entity separate from the financial entity that maintains the primary account 62. As shown in FIG. 6, the processing starts in step 330 and passes to step 332. In step 332, the user designates the bank operating system, i.e. the bank, that the particular account is associated with. For example, the user might select from a list of the user's banks, or a listing of approved banks in general, that are included in the integrated system. Then, the process passes to step 334.

In step 334, the user selects an account type for the added account. For example, as described in further detail herein, a choice may be made between a “general account” or a “specialized account”. Illustratively, a specialized account might be in the form of a “529 account” as described above, i.e., and such specialized account being associated with an “account control rule set” (AC rule set), as described above. In accordance with an embodiment of the invention, a specialized account may include a special set of rules to control processing associated with the account. The special set of rules may impose particular constraints associated with transactions of the account. For example, the rules associated with a specialized account might include rules that limit the type of merchants with which transactions may be performed, the dollar limits of transactions, the frequency of transactions, the type of deposit which may be made into the specialized account, access to the account or other attributes or parameters associated with the account. In the example of a “529 account” the rules may control the type of purchases which may be made with the account. That is, with the 529 account, the rules may mandate that only educational purchases may be made with the particular account.

After step 334 of FIG. 6, the process passes to step 335. In step 335, the system (based on the particular account type chosen by the user) determines what aspects of the particular account type are changeable after creation of the account. The system then advises the user regarding such information. For example, the user may not be able to change some attributes of a “529 account” relating to the type of purchase that may be made with the account, i.e. educational type purchases. Accordingly, the system clearly advises the customer on limitations and/or constraints of the particular type of account the user is creating. Accordingly, in step 336, the system imposes “accounts type rules” based on the particular type of account. After step 336, process passes to step 337.

In step 337, the system interfaces with the user to set further rules, within the constraints of the particular account type chosen by the customer. Further details of such processing are described below with reference to FIG. 7 in step 340. In particular, such further rules of step 337 may include customer preferences such as type of communication. After step 337, the process passes 339.

In step 339, the processing reflects that the secondary account has been created and associated with the user. Then, the processing returns to FIG. 3, and specifically passes to step 370 of FIG. 3.

FIG. 7 is a flowchart showing in further detail the “interface with user to set respective rules for use of a particular account in the user's account set” step 3 for a FIG. 3, in accordance with one embodiment of the invention. With the processing of FIG. 7, the user may change rules, such as preferences the user is allowed to change, of any of the user's integrated account 51. Accordingly, distinct from the processing of FIG. 7, the processing of FIG. 6 relates to the setting of rules associated with a new account added to the integrated account 51. It is appreciated that rules and/or the type of rules described as changeable with reference to FIG. 7 might also be applicable to the change of rules with reference to FIG. 6, and vice a versa.

After the processing of FIG. 7 starts in step 340, the process passes to step 342. In step 342, the user selects the particular account (in the user's account set 51′) that the user wants to make changes to the rules. After step 342, the process passes to step 344. In step 344, the system presents the user with rule change options that are available to change. In some embodiments, it is appreciated that such rule change options might include the ability to change account types if allowed, or to change particular attributes of an account type. However, with some specialized accounts it may well be the case that the user is not allowed to change account type. For example, if the account is a 529 account, the user might be precluded from changing the account type. It may well be the situation that the user may not be able to change many or any account types. In general, as reflected in box 344′ of FIG. 7, the user may only be provided the ability to change rules within the constraints of the bank operating system and/or within the constraints of the particular account type. After step 344 of FIG. 7, the processing passes to step 346.

In step 346, the system interfaces with the user to effect change in rules that pertain to one or more accounts of the user in the user's account set 51′. Rules set by the user, i.e. able to be changed by the user, to constrain or control use of the particular account may relate to merchants with which purchases may be made, including online purchases and purchases at brick and mortar stores. The rules may also relate to merchant types (with which purchases may be made), the maximum value of purchases, the minimum value of purchases, the time of day in which purchases may be made, the day of the week in which purchases may be made, the type or nature of items that may be purchased using the account and/or other attributes.

After the processing of step 346 of FIG. 7, the process passes to step 339. Step 339 reflects that the rule change is completed by the user, and processing returns to FIG. 3, and specifically step 370 of FIG. 3.

FIG. 8 is a flowchart showing in further detail the “interface with the user to set up a payment” step 350 of FIG. 3, in accordance with one embodiment of the invention. As shown, the processing starts in step 350, and passes to step 352. In step 352, the user interfaces with the system, such as the bank operating system 60, to schedule a desired payment, in accordance with one embodiment of the invention. Scheduling of the payment may include, for example, setting the payee and providing information regarding the payee such as account particulars, setting the date of the payment, setting the amount of the payment, and/or setting any contingencies of the payment. After the processing of step 352, the process passes to step 354.

In step 354, the user interfaces with the system to set interrelationships between payments and/or deposits of accounts. Such interrelationships might include which accounts should be debited first, which accounts should be deposited first, and other related and/or dependent factors. Illustratively, the processing between multiple accounts might be dependent on a particular split of accounts, a particular hierarchical ranking of accounts, or a particular threshold of some value. For example, an incoming payment of $100 might be split 60/40 between two predetermined accounts resulting in a deposit of $60 being deposited into the first account and $40 being deposited into the second account. Such interrelated processing between accounts may include both primary accounts 62 as well as a secondary account 72, for example. The primary accounts 62 and a secondary accounts 72 might be treated equally, or treated differently in some predetermined manner. For example, the user might set a rule that a particular payment is made to a vendor from the user's primary accounts 62, unless the balance of the primary account 62 has attained some predetermined threshold. In such situation that the primary account has attained some predetermined threshold, the rule might specify that the payment is made from a particular secondary account. Accordingly, in some embodiments, there may be no difference in processing between a primary account 62 of the user vis-à-vis a secondary account (72, 82, 92) of the user.

After step 354 of FIG. 8, the process passes to step 356. In step 356, the user interfaces with the system to set notices to be provided to the user upon certain events occurring. For example, the notices might be set to trigger upon a payment due date approaching or a payment being made from a particular account, for example. The particular nature and channel upon which a notice (or alert) is transmitted may vary between different accounts of the user, be those accounts a primary account 62 or a secondary account (72, 82, 92).

After step 356 of FIG. 8, the processing passes to step 359, in accordance with one embodiment of the invention. In step 359, the payment or payments desired by the customer are scheduled. Processing then returns to FIG. 3, and specifically step 370.

FIG. 9 is a flowchart showing in further detail the “interface with user to set communication preferences including what communication channel or channels the user receives communications on, in accordance with one embodiment of the invention. The communications might include a notice or an alert. A “notice” might be characterized as a communication documenting a scheduled transaction or some other anticipated event. On the other hand, an “alert” might be characterized as a communication documenting an unexpected event, such as a suspect transaction. For example, a suspect transaction might be identified by an observed transaction taking place in a geographical location distinct from the customer's expected geographical locale.

After the process starts in step 360, the process passes to step 362. In step 362, the user interfaces with the system to designate specific user devices and specific communication channels for communications between the system and each user device. In addition to the general settings of step 362, the user may additionally vary the communication channels utilized in steps 364, 365 and 367. That is, in step 364, the user may designate the particular communication channel on which to send “notices” regarding accounts. In embodiments, the user can specify different channels for different accounts. Then, in step 365, the user may designate a particular communication channel on which to send “alerts” regarding accounts. Again, the user can specify different channels for different accounts. Further, in step 367, the user is provided the ability to specify different communication channels for different types of accounts. It is appreciated that a customer, financial entity, or other entity may be provided the opportunity to specify communication channels for any of a wide variety of communications, as desired. For example, a communication channel for a particular type of communication might be specified by setting a particular preference. For example, such might include the user choosing different channels for general accounts versus specialized accounts. Also for example, communication channels might be specified on a transaction basis, such that notification regarding a first type of transaction would be output to the customer on a first communication channel, and notification regarding a second type of transaction would be output to the customer on a different second communication channel. It is appreciated there may be various interrelationship between the processing of steps 362, 364, 365, and 367. Such interrelationship might be handled in some hierarchical manner, i.e. one setting trumps another setting, or in some other suitable manner.

After the processing of step 367, the process passes to step 369. Step 369 reflects that the communication preferences are set by the user, and the processing then returns to FIG. 3, and specifically step 370 of FIG. 3.

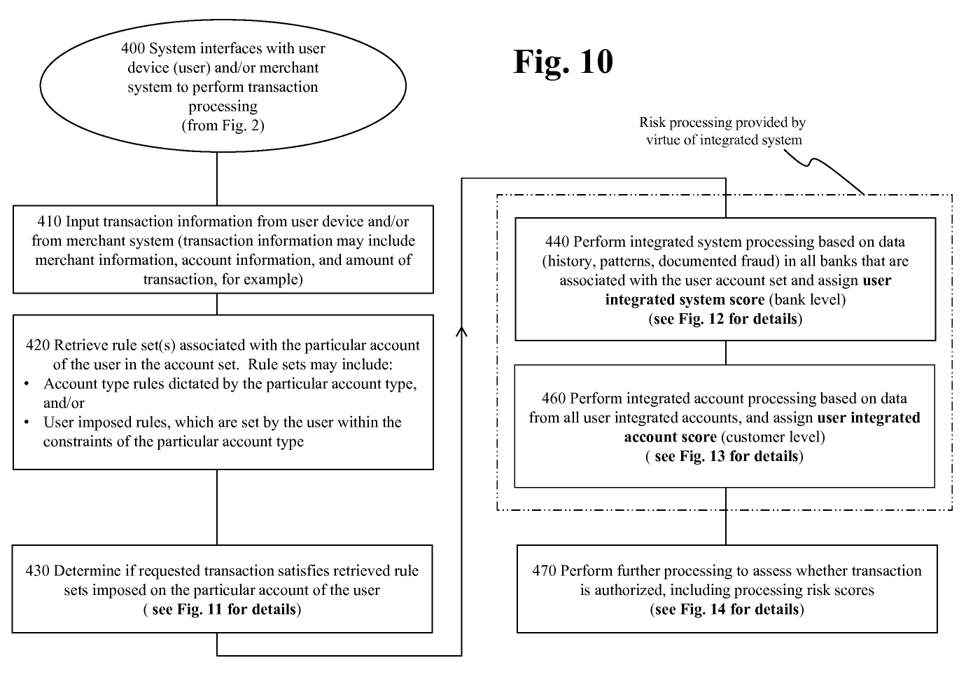

FIG. 10 is a flowchart showing in further detail the “system interfaces with the user device and/or merchant system to perform transaction processing” step 400 of FIG. 2, in accordance with one embodiment of the invention. The processing of FIG. 10 starts in step 400 and passes to step 410. In step 410, the system inputs transaction information from the user device and/or from the merchant system. The transaction information may include merchant information (such as a merchant identification number and/or merchant type), account information of the user, and the amount of the transaction, for example. After step 410, the process passes to step 420.

In step 420, the system retrieves the rule set or sets that are associated with the particular account of the user in the account set. The rule sets may include account type rules that are dictated by the particular type of account and/or user imposed rules. The user imposed rules are set by the user within the constraints of the particular account type, in accordance with one embodiment of the invention. After the processing of step 420, the process passes to step 430.

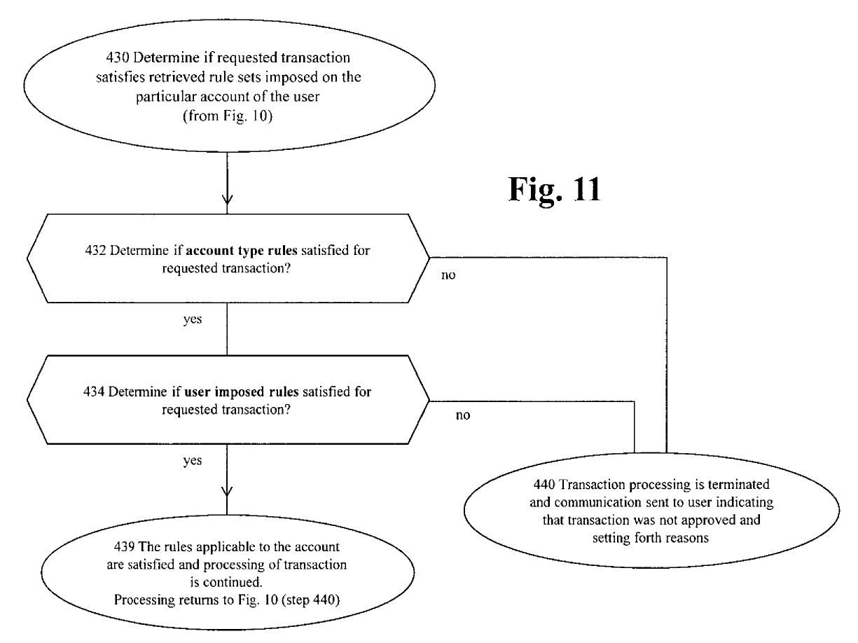

In step 430, the system determines if the requested transaction satisfies the retrieved rule sets imposed on the particular type of account. Further details of the processing of step 430 are described below with reference to FIG. 11. After the processing of step 430, the process passes to step 440.

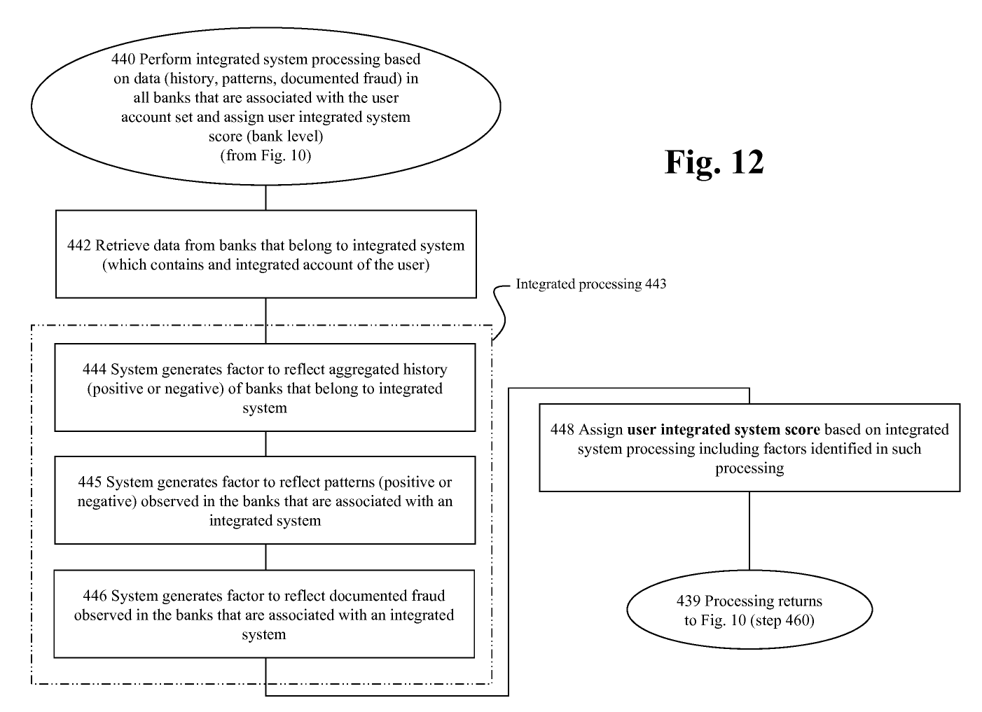

As is shown in FIG. 10, steps 440 and 460 reflect the enhanced risk processing provided by virtue of the integrated system 50. Specifically, in step 440, the system performs integrated system processing based on data in all banks, i.e. financial entities, that are associated with the user account set. As described in further detail below, such data might include history of account or accounts, patterns observed in accounts, and/or documented fraud observed in accounts. As a result of such processing, the particular transaction is assigned a user integrated system score. The user integrated system score might be characterized as being at a “bank level.” Further details of the processing of step 440 are described below with reference to FIG. 12.

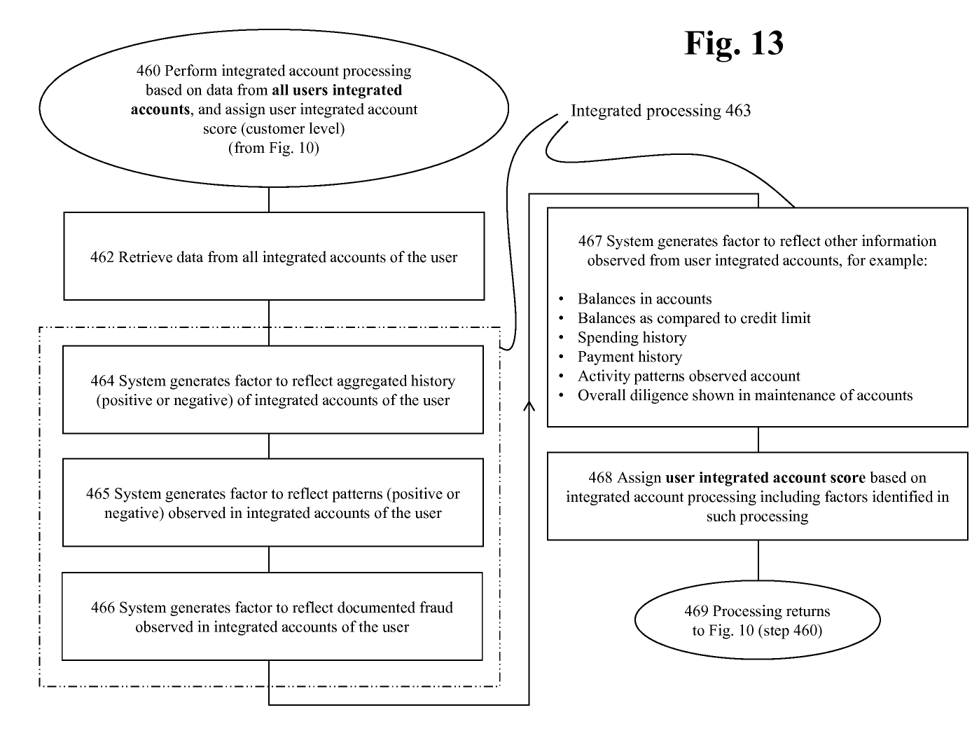

After step 440, the processing passes to step 460. In step 460, the system performs integrated account processing based on data from all user integrated accounts. As a result of such processing, a user integrated account score is assigned to the particular transaction. In contrast to the user integrated “system” score, the user integrated “account” score might be characterized as being at the “user level.” Further details of the processing of step 460 are described below with reference to FIG. 13.

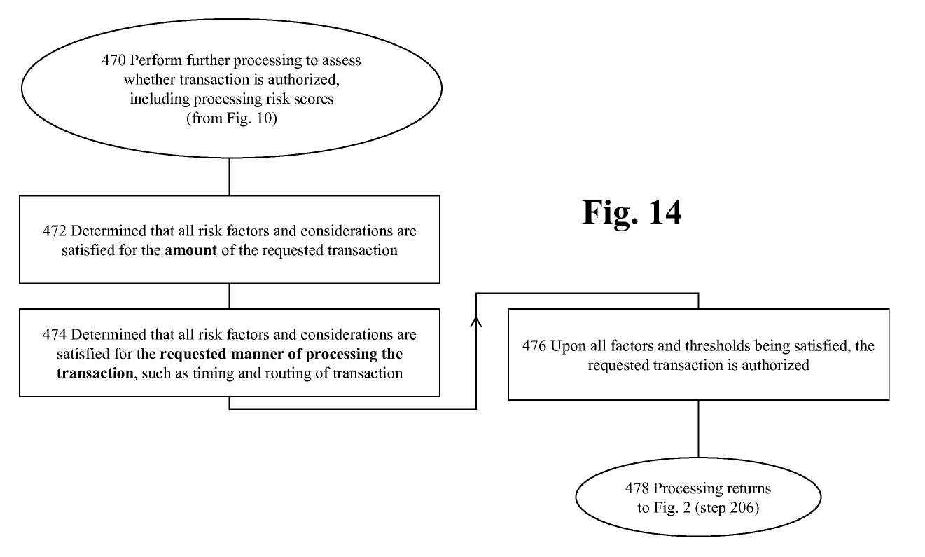

After the processing of step 460, the process passes to step 470. In step 470, the system performs further processing to assess whether the transaction will be authorized by the bank operating system 60. The determination of whether the transaction will be authorized includes processing the risk scores generated in step 440 and 460. Further details of the processing of step 470 are described below with reference to FIG. 14.

FIG. 11 is a flowchart showing in further detail the “determine if requested transaction satisfies retrieved rule sets imposed on the particular account of the user” step 430 of FIG. 10, in accordance with one embodiment of the invention. As shown, the processing starts in step 430 and passes to step 432. In step 432, the system determines if account type rules are satisfied for the requested transaction. That is, the account type rules are imposed by the system and not changeable nor imposed by the particular user. For example, the account type rules might be dictated by the particular type of account. If the determination is yes in step 432, then the process passes to step 434.

In step 434, the system determines if user imposed rules are satisfied for the requested transaction. That is, the user imposed rules are set by the user, within the constraints of the particular account type, and are changeable by the user. If the user imposed rules are satisfied in the determination of step 434, then the processing advances to step 439.

In step 439, the system concludes that the rules applicable to the account are satisfied and, as a result, processing of the transaction is continued. Processing then returns to FIG. 10, and specifically step 440 of FIG. 10.

With further reference to step 432 of FIG. 11, if the determination is no in step 432 (the account type rules are not satisfied for the requested transaction), then the process passes to step 439. In similar manner, with further reference to step 434 of FIG. 11, if the determination is no in step 434 (the user imposed rules are not satisfied for the requested transaction) then the process also passes to step 439.

In step 439, the transaction processing is terminated for the requested transaction and a suitable communication is sent to the user. The communication may be sent via some predetermined channel and indicate that the transaction was not approved. The communication may set forth suitable reasons for the non-approval.

FIG. 12 is a flowchart showing in further detail the “perform integrated system processing based on data in all banks that are associated with the user account set and assign user integrated system score” step 440 of FIG. 10, in accordance with one embodiment of the invention. As shown, the process starts in step 440 and passes to step 442. In step 442, the system, such as the bank operating system 60, retrieves various data from banks that belong to the integrated system 50. That is, such banks may include any bank which contains an integrated account of the user. After step 442, the system performs integrated processing 443. The integrated processing 443 includes processing various aggregated information across the various banks in the integrated system, i.e., the banks associated with each of the customer's integrated accounts 51, in accordance with one embodiment of the invention. In other embodiments, it is appreciated that only select banks and/or select accounts of the user might be utilized in such integrated processing. The particular banks and/or the particular accounts that are utilized in such integrated processing (and the particular banks and/or the particular account that are not utilized) may be determined by the system in some predetermined manner. In one example, such integrated processing may only use information from accounts (and the banks associated with those accounts) that have been opened within some predetermined amount of time. For example, if an account has been opened less than 3 months, then the bank operating system 60 may not use information associated with such account.

As noted above, the integrated processing 443 of FIG. 12 includes step 444, step 445, and step 446. In step 444, the system generates a factor or factors to reflect aggregated history (positive or negative) of banks that belong to the integrated system. For example, if a particular bank that belongs to the integrated system (i.e. a bank that maintains one of the integrated accounts 51 of the user) has a particularly problematic history or is known to be associated with fraud—then such bank may adversely affect a factor representative of the aggregated history of the banks in the integrated system.

After step 444, the process passes to step 445. In step 445, the system generates a factor to reflect patterns (positive or negative) observed in banks that are associated with the integrated system by virtue of association with an integrated account 51 of the user.

After step 445, the processing passes to step 446. In step 446, system generates a factor or factors to reflect documented fraud observed in the banks that are associated with the integrated system. In step 446, the processing passes to step 448.

In step 448, the system assigns a user integrated system score based on the integrated system processing 443. The assignment of the user integrated system score may be based on the factors determined in the processing of steps 444, 445, and 446. After step 448, the process passes to step 439.

In step 439, the processing returns to FIG. 10, and specifically returns to step 460 of FIG. 10.

FIG. 13 is a flowchart showing in further detail the “perform integrated account processing based on data from all user's integrated account, and assign the user integrated account score (customer level)” step 460 of FIG. 10, in accordance with one embodiment of the invention. As shown in FIG. 13, the processing starts in step 460 and passes to step 462. In step 462, the processing retrieves data from all the integrated accounts of the user.

After step 462, the system performs integrated processing 463. The integrated processing 463 includes processing various aggregated information across the various accounts in the account set of the user, in accordance with one embodiment of the invention. Specifically, the integrated processing 463 includes the processing of steps 464, 465, and 466 in FIG. 13. In step 464, the system generates a factor to reflect aggregated history of the integrated accounts, including both positive and negative history. In step 465, the system generates a factor to reflect patterns observed in the integrated accounts of the user, including both positive and negative patterns. Additionally, in step 466, the system generates a factor to reflect documented fraud observed in the integrated accounts of the user.

After step 466 of FIG. 13, the process passes to step 467. The integrated processing also includes such step 467.

In step 467, the system generates a factor to reflect other information observed from the various integrated accounts of the user. Such further generation of a factor may reflect information relating to balances in integrated accounts of the customer, balances as compared to respective credit limits in integrated accounts, spending history in integrated accounts, payment history and integrated accounts, activity patterns observed in integrated accounts, and/or overall diligence shown in maintenance of integrated accounts. After step 467 of FIG. 13, the process passes to step 468.

In step 468, the system assigns a user integrated account score based on the integrated account processing 463, including factors identified in such processing. In assigning the user integrated account score of step 468, it is appreciated that the processing and factors assigned in each of steps 464, 465, 466, and 467 may be combined, weighted, or otherwise synthesized in any suitable manner as desired.

After step 468 of FIG. 13, the process passes to step 469. In step 469, the process returns to FIG. 10, and specifically returns to step 460 of FIG. 10.

FIG. 14 is a flowchart showing in further detail the “perform further processing to assess whether the transaction is authorized including processing risk scores” step 470 of FIG. 10, in accordance with one embodiment of the invention. As shown, the process starts in step 470 and passes to step 472.

In step 472, the system determines that all risk factors and considerations are satisfied for the amount of the requested transaction. After step 472, the process passes to step 474. In step 474, the processing determines that all risk factors and considerations are satisfied for the requested manner of processing the transaction. In particular, for example, the particular manner of processing the requested transaction might include the requested timing of the transaction and/or the requested routing of the transaction. For example, a deposit into an integrated account of the user may be performed immediately if such deposit funds is determined to be low in risk. On the other hand, the particular financial entity processing the transaction may mandate a delay in the deposit of such is viewed as more risky.

After step 474 of FIG. 14, the process passes to step 476. In step 476, the system deems that all factors and thresholds are satisfied for the particular manner of processing the transaction, and the requested transaction is thus authorize. After step 474, the process passes to step 478.

In step 478, the processing returns to FIG. 2, and specifically the processing returns to step 206 of FIG. 2.

FIG. 15 is a flowchart showing in further detail the “system interfaces with and outputs information to the bank operating system and/or merchant” step 500 of FIG. 2, in accordance with one embodiment of the invention. As shown, the processing starts in step 500 and passes to step 502.

In step 502, the system assesses and reports various aspects of activity in all integrated systems and/or all integrated accounts of the user. Then, in step 504, the system assesses and reports fraud in integrated systems and/or integrated accounts of the user. Then, in step 506, the system aggregates data from activity in the integrated accounts of the user for target marketing purposes. Additionally, for example, in step 508, the system performs processing to determine share of wallet between integrated accounts of the user.

In general, the processing of steps 502, 504, 506, and 508 reflect that a wide variety of data relating to the integrated accounts of a user (and financial entities associated with those integrated accounts of the user) may be retrieved and used for various purposes in addition to transaction processing. It is of course appreciated that such retrieval and use of data is limited to any applicable agreements, rules and/or regulations, for example. Thus, for example, in performing the processing of FIG. 15, a financial entity might be limited in the particular nature of information regarding other financial entities and/or the manner in which information regarding other financial entities might be utilized. Relatedly, it is appreciated that information might be utilized for some purposes and not utilized for other purposes. For example, it might be the case that information from another financial entity is indeed able to be utilized for fraud prevention (in processing transactions for example) but not acceptable nor permitted for use in target marketing endeavors.

With further reference to FIG. 15, after step 508, the processing passes to step 509. In step 509, the processing returns to FIG. 2, and specifically to step 206 of FIG. 2. Further processing is then performed as described above.

The systems and methods of the invention are described above in terms of processing associated with a “bank.” However, it is appreciated that any such processing described in the context of a “bank” (or any other particular financial entity) is not limited to such particular environment. That is, such processing might be performed by any financial entity, as desired.

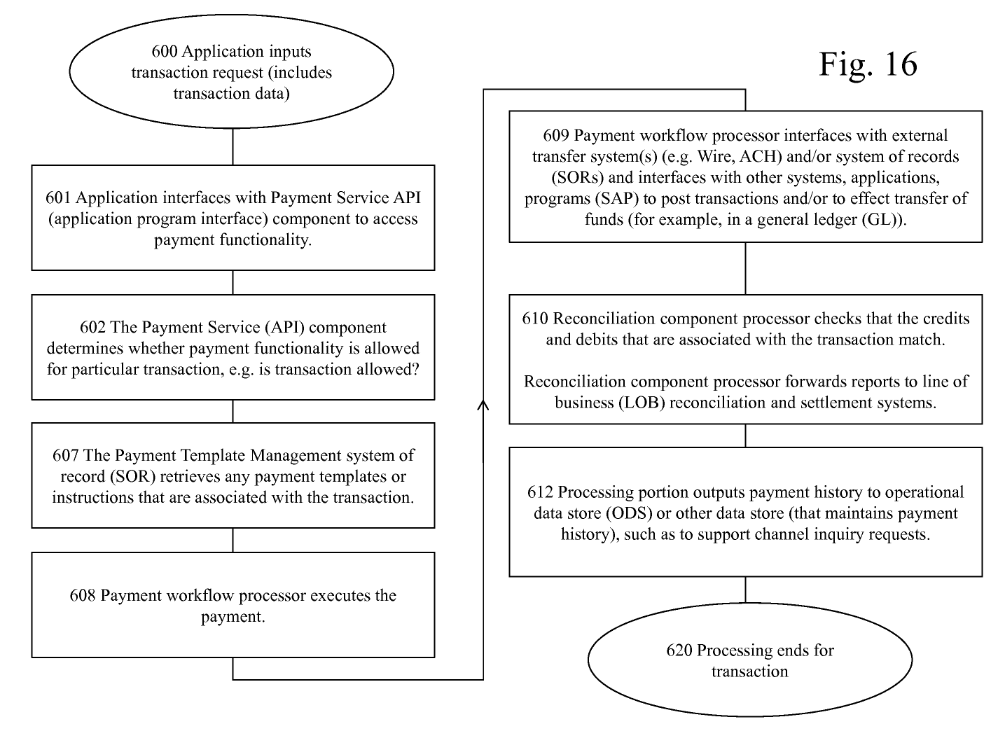

It is appreciated that the payment processing described herein may be utilized for various different types of payments between various different types of entities. For example, the transaction request may be from a first customer to perform a purchase from a merchant, such as a purchase of an item or service, for example. The payment processing is not limited to merchants, such as online merchants or brick-and-mortar merchants. For example, the payment processing described herein may be used by a customer to make a payment to a financial entity as desired, such as to a bank, for example. The processing may be used by a customer to schedule payments to repay a loan, mortgage, or other debt. Also, the payment processing may be used to perform transfer of funds between people (person-to-person), such as between a first customer and a second customer, for example. In addition, the processing may be utilized for a transfer of funds internally in a financial entity. For example, the payment processing described herein might be utilized to pay a CHASE loan (e.g. mortgage) from a CHASE checking account using a CHASE owned payment system. Such transfer of funds would be internal to CHASE. However, in accordance with embodiments of the invention, the processing associated with the transfer of funds may use the integrated accounts of the customer to assess attributes associated with such internal transfer of funds, such as risk associated with such transfer of funds. Accordingly, information regarding the customer's integrated accounts (including accounts in different external financial entities) may indeed be utilized to assess the attributes of a transfer of funds internal to the financial entity. In summary and further illustration of features of the invention, FIG. 16 is a flowchart showing processing performed by a payment system, in accordance with one embodiment of the invention.

The processing of FIG. 16 starts in step 600. In step 600, a payment application inputs a transaction request, which includes transaction data. Then, the process passes to step 601. In step 601, the particular application interfaces with a payment service application program interface (API) component so as to access payment functionality. Then, in step 602, the payment service API component determines whether payment functionality is allowed for the particular transaction. That is, the payment service API component determines whether the particular transaction initiated by the application is allowed. Then, the process passes to step 607.

In step 607, a payment template management system of record (SOR) retrieves any payment templates or instructions that are associated with the particular transaction. Then, in step 608, a payment workflow processor executes the payment. Then, the process passes to step 609.

In step 609, the payment workflow processor interfaces with an appropriate external transfer system and/or an appropriate system(s) of record (SORs) and may also interface with other systems, applications, and programs (SAP) to post transactions and/or to effect transfer of funds. For example, such activity might be performed in a general ledger (GL). After step 609, the process passes to step 610.

In step 610, a reconciliation component processor checks that the credits and debits that are associated with the particular transaction match. Further, the reconciliation component processor forwards reports to the appropriate line of business (LOB) reconciliation and settlement systems.

Then, in step 612, a processing portion outputs payment history to an operational data store (ODS) or other data store that maintains payment history. Such payment history (in such data store) may be utilized to support channel inquiry requests, for example.

Then, the process passes to step 620. In step 620, the process ends for the particular transaction.

In summary, in accordance with embodiments of the invention, a primary financial entity maintains a “primary system of record.” For example, the primary financial entity might be a financial entity such as JPMORGAN CHASE. The primary system of record maintains various accounts for various customers. As should be appreciated, such accounts and customers may be substantial, numbering into the millions. In addition to the primary system of record, the payment system of the invention is also integrated with what are herein characterized as “external systems of record.” Such an external system of record might be in the form of a system maintained by another financial entity, such as a system of record maintained by WELLS FARGO.

In the payment system of the invention, payment processing involving a primary system of record is integrated with payment processing involving an external system (or systems) of record. In other words, in such payment processing, an external account (of a customer) residing in an external system of record is effectively treated as if it was within the system of record for the primary financial entity. As a result, in accordance with aspects of the invention, accounts and related transactions in an external system of record may be integrated and aggregated with transactions and accounts disposed in the primary system of record.

Hereinafter further aspects of implementation will be described.

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example. As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, RUM Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A system that performs payment processing amongst a variety of financial entities responsive to a risk determination based on aggregated data from disparate financial entities, the system in the form of a tangibly embodied computer processor maintained by a primary financial entity, the system comprising:
an integrated record interface that accesses at least one primary system of record created and maintained by a primary financial entity that issues and maintains customer financial accounts and at least one external system of record created and maintained by a financial entity separate from the primary financial entity that issues and maintains customer financial accounts wherein the customer financial accounts comprise one or more of a savings account, a checking account, a debit account, and a credit card account;
a payment processing engine comprising an enterprise payment hub that communicates to a computer system for each of the plurality of secondary financial entities, a plurality of retail merchant computer systems, and a plurality of customer devices;
the payment processing engine comprises an electronic input that receives a retail transaction request, for a first customer, from at least one of a first retail merchant computer system and a first customer device of the first customer;
payment processing engine, coupled to the integrated record interface, and programmed to:
determine if the retail transaction request satisfies a set of rules;
execute processing on aggregated data to determine a risk associated with the retail transaction request, the aggregated data including data associated with (1) an account of the first customer maintained by the primary financial entity, and (2) at least one financial account capable of rendering payments for goods and services of the first customer maintained by a secondary financial entity wherein the aggregated data is associated with a plurality of accounts of the first customer maintained by respective secondary financial entities in which (1) the plurality of accounts of the first customer maintained by respective secondary financial entities and (2) the account of the first customer maintained by the primary financial entity collectively constituting an account set of integrated accounts, wherein the aggregated data comprises data from each integrated account in the account set of the first customer;
wherein an account control rule set schedules payment from or deposit to an account of the integrated accounts, the account control rule set comprises at least a first rule set for a specialized account limited to a specific type of purchase including educational related purchases and a second rule for a general account;
integrate transaction activity associated with the secondary financial entity into a customer profile associated with the primary financial entity, the customer profile comprising monitored transaction activity data across a variety of disparate financial entities including the primary financial entity and the secondary financial entity;
upon determining that (1) the transaction does satisfy the set of rules and (2) that the risk associated with the transaction request satisfies a threshold value, the payment processing engine authorizing the transaction request, and
output, via a communication network, an electronic communication, to at least one of the first merchant computer system and the first customer device, indicating approval of the transaction.

2. (canceled)

3. (canceled)

4. (canceled)

5. The system of claim 1, the integrated accounts respectively constituted by at least one of a credit card account, a stored value card account, a debit card account, a savings account, and a mortgage account.

6. The system of claim 1, the determining a risk associated with the transaction request including basing the risk determination on data at a financial entity level, for each of the secondary financial entities associated with the integrated accounts.

7. The system of claim 1, the determining a risk associated with the transaction request including basing the risk determination on aggregated history relating to each of the integrated accounts of the first customer.

8. The system of claim 1, the determining a risk associated with the transaction request including basing the risk determination on patterns observed in the integrated accounts of the first customer.

9. The system of claim 1, the determining a risk associate with a transaction request including basing the risk determination on documented fraud observed in the integrated accounts of the first customer.

10. The system of claim 1, the determining a risk associated with the transaction request including basing the risk determination on at least one of aggregated history relating to integrated accounts, patterns observed in integrated accounts, and fraud observed in integrated accounts.

11. The system of claim 10, the determining a risk associated with the transaction including basing the risk determination on at least one of balances in accounts, balances as compared to credit limit, spending history, payment history, and diligence observations.

12. The system of claim 10, the determining a risk associated with the transaction including basing the risk determination on each of balances in accounts, balances as compared to credit limit, spending history, payment history, and diligence observations.

13. The system of claim 1, the set of rules including both (1) rules dictated by the particular type of account and (2) rules controlled by the user.

14. The system of claim 1, at least one of the integrated accounts being in the form of a general account or a specialized account, such form being selected by the user in conjunction with creating the account by the user.

15. The system of claim 14, at least one of the integrated accounts being in the form of a specialized account, such specialized account including specific rules, the specific rules dictated by the particular type of specialized account chosen by the user.

16. The system of claim 15, the specialized account constituted by an account that includes rules conforming to a 529 plan of the U.S. Internal Revenue Code, as of the date of filing, such rules controlling that purchases made with such specialized account is limited to educational related purchases.

17. The system of claim 1, the transaction request is from the first customer to perform a purchase from a merchant.

18. The system of claim 17, the purchase is for an item or service.

19. The system of claim 1, the transaction request is from the first customer to perform a payment to an entity.

20. The system of claim 19, the entity is one of a financial entity, a bank, a merchant, and a vendor.

21. The system of claim 20, the entity is a financial entity and the transaction is constituted by a payment to satisfy a loan.

22. The system of claim 1, the transaction request is from a first customer for a transfer of funds from the first customer to a second customer.

23. The system of claim 1, the transaction request is from a first customer for a transfer of funds from a second customer to the first customer.

24. A method to perform payment processing amongst a variety of financial entities responsive to a risk determination based on aggregated data from disparate financial entities, the method performed on a system in the form of a tangibly embodied computer processor maintained by a primary financial entity, the method comprising:
accessing, via an integrated record interface, at least one primary system of record created and maintained by a primary financial entity that issues and maintains customer financial accounts and at least one external system of record created and maintained by a financial entity separate from the primary financial entity that issues and maintains customer financial accounts wherein the customer financial accounts comprise one or more of a savings account, a checking account, a debit account, and a credit card account;
providing, via a payment processing engine comprising an enterprise payment hub that communicates to a computer system for each of the plurality of secondary financial entities, a plurality of retail merchant computer systems, and a plurality of customer devices;
receiving, via an electronic input of the payment processing engine, a retail transaction request, for a first customer, from at least one of a first retail merchant computer system and a first customer device of the first customer;
performing processing of the retail transaction request to authorize the retail transaction, such processing including:
determining, via the payment processing engine, if the retail transaction request satisfies a set of rules;
executing, via the payment processing engine, processing on aggregated data to determine a risk associated with the transaction request, the aggregated data including data associated with (1) an account of the first customer maintained by the primary financial entity, and (2) at least one financial account capable of rendering payments for goods and services of the first customer maintained by a secondary financial entity wherein the aggregated data is associated with a plurality of accounts of the first customer maintained by respective secondary financial entities in which (1) the plurality of accounts of the first customer maintained by respective secondary financial entities and (2) the account of the first customer maintained by the primary financial entity collectively constituting an account set of integrated accounts; wherein an account control rule set schedules payment from or deposit to an account of the integrated accounts, the account control rule set comprises at least a first rule set for a specialized account limited to a specific type of purchase including educational related purchases and a second rule for a general account;
integrating, via the payment processing engine, transaction activity associated with the secondary financial entity into a customer profile associated with the primary financial entity, the customer profile comprising monitored transaction activity data across a variety of disparate financial entities including the primary financial entity and the secondary financial entity;
upon determining that (1) the transaction does satisfy the set of rules and (2) that the risk associated with the transaction request satisfies a threshold value, the payment processing engine authorizing the transaction request, and
outputting, via a communication network, an electronic communication, to at least one of the first merchant computer system and the first customer device, indicating approval of the transaction.

25. (canceled)
